(19) United States
(12) Patent Application Publication
(10) Pub. No.: US 2013/0285503 A1
(43) Pub. Date: Oct. 31, 2013

(54) Commutator Motor

(71) Applicant: JOHNSON ELECTRIC S.A., Murten (CH)

(72) Inventors: James Ching Sik LAU, Hong Kong (CN); Kwong Yip POON, Hong Kong (CN); Ning HUANG, Shenzhen (CN); Ting HE, Shenzhen (CN); Jian Ping JIN, Shenzhen (CN)

(73) Assignee: Johnson Electric S.A., Murten (CH)

(21) Appl. No.: 13/873,014

(22) Filed: Apr. 29, 2013

(30) Foreign Application Priority Data
Apr. 28, 2012 (CN) 201210133091

(51) Int. Cl. H02K 13/04

(52) U.S. Cl. CPC H02K 13/04
USPC 310/234

(57) ABSTRACT

A commutator motor has a stator, brushes and a rotor. The rotor has a shaft, a rotor core fixed to the shaft, a number of coils wound about the rotor core and a commutator fixed to the shaft next to the rotor core. The commutator has a base and a number of commutator bars fixed to the base in sliding contact with the brushes. The rotor core includes a number of pole bodies extending substantially radially outwards. Each pole body includes a connecting surface at an axial end of the rotor core. The commutator base includes a number of connecting arms extending substantially radially outwards and contacting the connecting surfaces of corresponding pole bodies. At least two of the coils are wound around a corresponding pole body and the connecting arm contacting the connecting surface of this pole body.

### CROSS REFERENCE TO RELATED APPLICATIONS

This non-provisional patent application claims priority under 35 U.S.C. §119(a) from Patent Application No. 201210133091.7 filed in The People's Republic of China on Apr. 28, 2012.

### FIELD OF THE INVENTION

The present invention relates to an electric motor having a commutator and in particular, to the connection between the commutator and a rotor core of the motor.

### BACKGROUND OF THE INVENTION

In a commutator motor, the rotor commonly includes a shaft, a rotor core fixed to the shaft, a commutator fixed to the shaft adjacent the rotor core and a number of coils wound about the rotor core. The commutator has a base and a number of commutator bars fixed to the base. The coils are connected to corresponding commutator bars. In an existing rotor, the commutator base is fixed to the rotor core by adhesive such as glue. However, during assembly, the step of gluing and the step of waiting for the glue to dry are needed. This lowers production efficiency. From another aspect, when the motor is used in a special environment, such as an environment full of coal-gas, the adhesive may volatilize and adhere to the surface of the commutator bars. This can lead to motor failure.

The present invention aims to provide a new rotor having a higher production efficiency and being able to work properly under certain special circumstances.

### SUMMARY OF THE INVENTION

Accordingly, in one aspect thereof, the present invention provides a motor comprising: a stator having magnetic poles; a plurality of motor terminals for connecting a power source; a plurality of brushes; and a rotor rotatably received in the stator, the rotor comprising: a rotor core having a plurality of pole bodies extending substantially radially outwards, each pole body having a connecting surface at an axial end of the rotor core; a commutator having a base supporting a plurality of commutator bars in sliding contact with the brushes, the base having a plurality of connecting arms that extend substantially radially outwards and in contact with the connecting surfaces of corresponding pole bodies; and a plurality of coils wound about the pole bodies and connected to the commutator bars, at least two of the coils are wound around a corresponding pole body and the connecting arm contacting the connecting surface of said corresponding pole body.

Preferably, the number of connecting arms is equal to the number of pole bodies.

Preferably, the connecting arms are evenly arranged in the circumferential direction of the rotor.

Preferably, the width of the connecting arm in the circumferential direction of the rotor is substantially equal to the width of the pole body.

Preferably, a ring-shaped varistor surrounds d is electrically connected to the commutator bars.

Preferably, a retaining ring is tightly sleeved on an end of the commutator bars to fix the commutator bars to the commutator base.

Preferably, the varistor is supported by and electrically connected to a plurality of conductive extending portions extending radially outwards from respective commutator bars, and radially surrounds the retaining ring.

Preferably, the rotor core has a groove in an axial end surface of the rotor core facing the commutator and the commutator has a protrusion protruding toward the rotor core and received in the groove for positioning the commutator with respect to the rotor core.

Alternatively, the rotor core has a substantially tubular root that is fixedly sleeves part of the shaft, the pole bodies extend from the root, a plurality of grooves are formed in an axial end of the root adjacent to the shaft and the commutator base has a plurality of protrusions received in the grooves.

Alternatively, or in addition, the rotor core has a substantially tubular root that fixedly sleeves part of the shaft and a plurality of pole heads, the pole bodies extend from the root to respective pole heads, a groove is formed in each joint between each pole body and the corresponding pole head and the commutator base has a number of protrusions respectively received in the grooves.

Alternatively, or in addition, the rotor core has a substantially tubular root that fixedly sleeves part of the shaft with the pole bodies extending from the root, and protrusions formed on the commutator base contact a radially outer surface of the root between adjacent pole bodies to circumferentially align the commutator with the rotor core.

Preferably, the stator comprises: a plurality of permanents magnets forming the magnetic poles; a housing that accommodates the permanents magnets; and an end cap that substantially closes an end of the housing, the end cap comprises an end plate and two projections extending perpendicularly from the end plate at spaced locations and abutting against an inner wall of the housing, each projection comprises a slot that receives a respective motor terminal and an end of a corresponding brush.

In embodiments of the present invention, the commutator is fixed to the rotor core during the step of winding the coils, which is a necessary step in producing a motor. Accordingly, the steps of gluing and waiting for the glue to dry are no longer needed. Compared to the existing motor described in the background, the production efficiency of the motor of the present invention is therefore relatively high.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 shows a motor according to a preferred embodiment of the present invention;

FIG. 2 is a partially exploded view of the motor of FIG. 1;

FIG. 3 shows a rotor of the motor of FIG. 2, in accordance with a first embodiment of the present invention;

FIG. 4 is a partially exploded view of the rotor of FIG. 3;

FIG. 5 shows a commutator base, being a part of the rotor of FIG. 4;

FIG. 6 shows a commutator base according to a second embodiment of the present invention; and

FIG. 7 is a view similar to FIG. 3, of a rotor according to a third embodiment of the present invention.

### DETAILED DESCRIPTION OF THE PREFERRED EMBODIMENTS

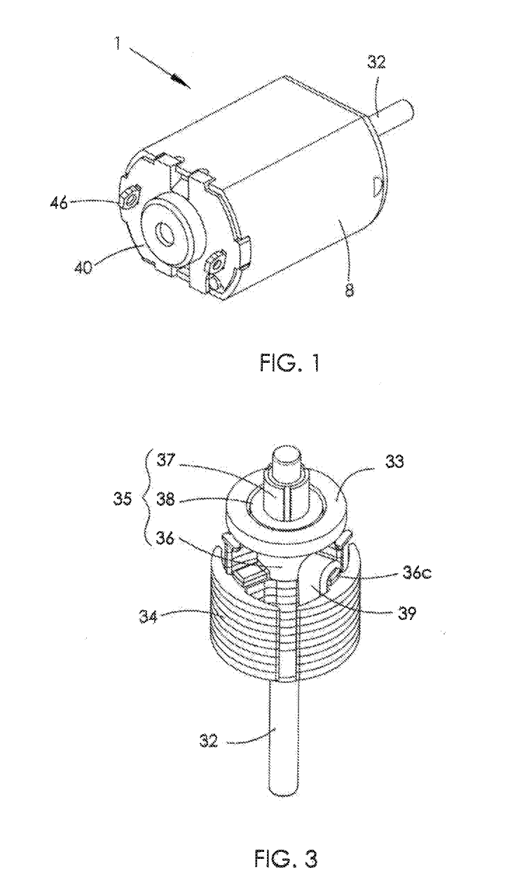

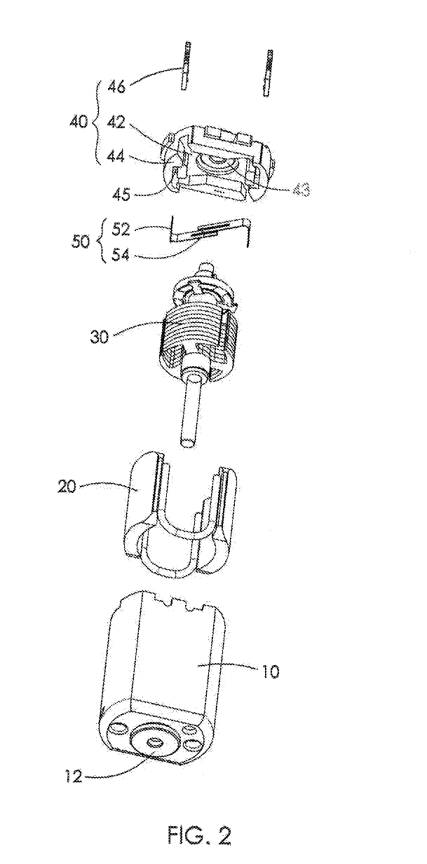

Referring to FIGS. 1 and 2, a motor 1 of the present invention includes a stator 8 and a rotor 30 housed in the stator 8. The stator 8 comprises a housing 10, a number of permanent magnets 20, an end cap 40, and two brushes 50. The housing 10 is substantially cup-shaped and the bottom thereof defines a first hole for housing a first bearing 12. The permanent magnets 20 are substantially curved plates and are fixed to opposite sides of an inner surface of the housing 10, forming a space there between for the rotor 30. The magnets are held against the inner surface of the housing by magnet springs.

Referring to FIGS. 3 to 5, the rotor 30 includes a shaft 32, a rotor core 34, a commutator 35, and a number of coils 39 (only one coil is shown in the figures).

The rotor core 34 includes a substantially tubular root 34a tightly fixed to the shaft 32, a number of pole bodies 34b extending radially from the root 34a, and a number of arcuate pole heads 34c connected to distal ends of corresponding pole bodies 34b. Each pole body 34b has a connecting surface 34d at its axial end. The rotor core is preferably formed by stacking a number of laminations formed from sheet electrical steel.

The commutator 35 includes a commutator base 36, a number of commutator bars 37, and a retaining ring 38. The base 36 includes a substantially tubular connecting part 36a, a substantially tubular fixing part 36b juxtaposed with the connecting part 36a, and a number of connecting arms 36c. The connecting part 36a includes a bearing surface 36d facing way from the fixing part 36b. The outer diameter of the connecting part 36a is greater than that of the fixing part 36b. The connecting arms 36c extend radially from an end of the connecting part 36a remote from the fixing part 36b, corresponding to respective pole bodies 34b. The connecting arms 36c cover corresponding bearing surfaces 36d. The bars 37 are arranged evenly about the outer surface of the fixing part 36b. The retaining ring 38 tightly sleeves an end of the bars 37 so as to fix the bars 37 to the base 36.

Each coil 39 is wound around a corresponding pole body 34b and the connecting arm 36c covering the connecting surfaces 34d of this pole body 34b. In this way, the base 36 is fixed to the rotor core 34. During winding, the coil 39 forces the connecting arm 36c to align with the connecting surface 34d of the connecting arm 36c.

Referring to FIG. 2, the end cap 40 includes an end plate 42, two projections 44 extending substantially perpendicularly from the end plate and substantially parallel to each other at spaced locations, and two motor terminals 46. The end plate 42 defines a second hole for housing a second bearing 43. Each projection 44 defines a slot 45. Each motor terminal 46 passes through the end plate 42 and an end thereof is received in a corresponding slot 45.

Each brush 50 includes a fixing portion 52 and a contact portion 54. The fixing portion 52 is assembled in a corresponding slot 45 and electrically contacts with a corresponding motor terminal 46, leaving the contact portion 54 free and extending generally towards the axis of the motor.

On assembly, the rotor 30 is arranged inside the housing 10 with one end of the shaft 32 received in the first bearing 12. The two contact parts 54 of the brushes press against the commutator bars 37. The two projections 44 are disposed in the opening of the housing 10 in a tight manner, while the other end of the shaft 32 is received in the second bearing 43. As such, the rotor is rotatably received in the housing 10 and the rotor core 34 is surrounded by the permanent magnets 20.

In the above embodiment of the present invention, the commutator 35 is assembled to the rotor core 34 during the step of winding the coils 39. As winding is a necessary step in producing a motor and the steps of gluing and waiting for the glue to dry are no longer needed. Compared to the existing motor described in the background, the production efficiency of the motor of the present invention is therefore relatively high, From another aspect, when the motor is used in a special environment, such as an environment containing a significant amount of coal-gas, no motor failure will occur due to the use of adhesive.

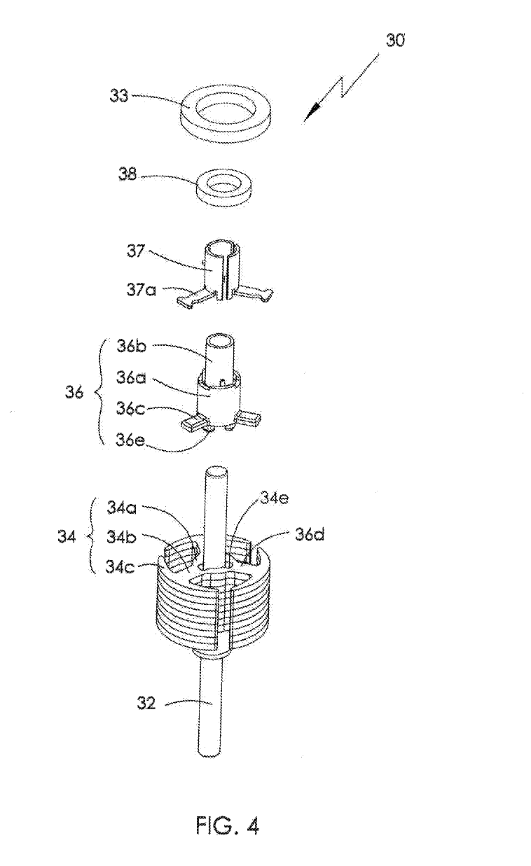

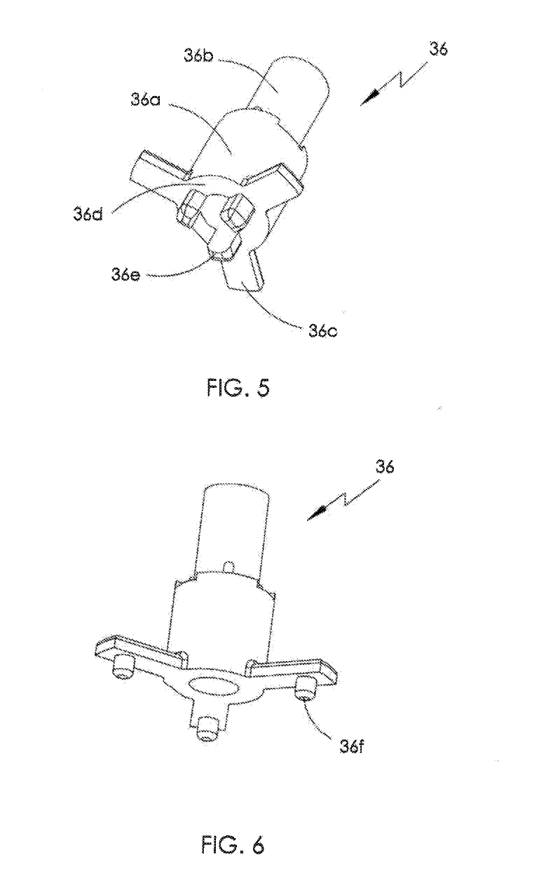

Preferably, referring to FIGS. 4 and 5, an axial end of the root 34a defines a number of first grooves 34e adjacent to the shaft 32. The base 36 further includes a corresponding number of first protrusion 36e protruding from the bearing surface 36d of the connecting part 36a. The first protrusions 36e are received in corresponding first grooves 34e. As such, the base 36 can be aligned with the rotor core 34 before winding the coils 39.

Alternatively, referring to FIG. 6, in other embodiments, where the rotor core 34 has a number of second grooves in the joints between each pole body 34b and the corresponding pole head 34c for positioning the laminations of the rotor core 34, the base may have a number of second protrusions 36f extending from the connecting arms 36c. The second protrusions 36f are received in the second grooves 34f for positioning function the commutator with respect to the rotor core before the windings are wound. The second protrusions may replace the first protrusions or be in addition to the first protrusions.

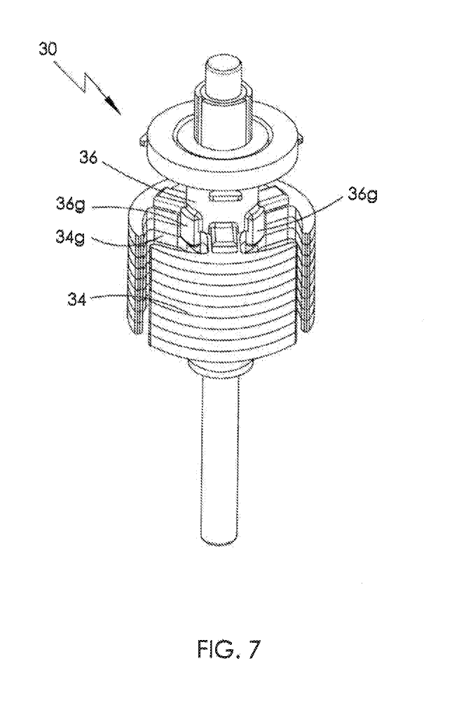

Alternatively, referring to FIG. 7, as coil slots 34g (grooves) are defined between adjacent pole bodies 34b for receiving the coils 39, the base 36 may have a number of third protrusions 36g protruding axially from the connecting part 36a. The third protrusions 36g are received in the coils slots 34g and tightly contact the outer surface of the root 34a between adjacent pole bodies 34b for locating the base with respect to the rotor core before winding the coils. Preferably, the third protrusions replace the first and second protrusions, but do not preclude the presence of other protrusions.

In summary, as long as the rotor core 34 includes at least one groove 34e, 34f, or 34g for receiving at least one protrusion 36e, 36f, or 36g, the base 36 can be positioned with respect to the rotor core before winding the coils 39.

Preferably, the width of the connecting arm 36c in the circumferential direction of the motor is substantially equal to that of the pole body 34b for better alignment with the connecting arm 36c with the pole body 34b. As such, the connecting arms 36c also provide protection for the wire of the coils from the edges of the rotor core during winding.

Preferably, referring to FIG. 4, the commutator 35 further includes a number of conductive extending portions 37a extending radially outwards from the bars 37 and a ring-shaped varistor 33. The varistor 33 surrounds the retaining ring 38 and is supported by and electrically connected to the extending portions 37a for suppressing electrical noise produced by the motor.

It should be understood that the base 36 can be molded to the bars 37. In this case, the retaining ring 38 can be eliminated.

In the above described embodiments, each and every pole body 34b is arranged with a connecting arm 36c for avoiding separation between the base 36 and the rotor core 34. However, in other embodiments, especially when the number of pole bodies is large, it is not necessary that every pole body is covered by a connecting arm. For example, if the rotor has 16 pole bodies, then the base may have only 8, 4, or even 2 connecting arms 36c evenly spaced and attached to corresponding pole bodies.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. A rotor of an electric motor, comprising:
a shaft;
a rotor core fixedly sleeving part of the shaft and comprising a plurality of pole bodies extending substantially radially outwards, each pole body comprising a connecting surface at an axial end of the rotor core;
a commutator base sleeving part of the shaft, the commutator base comprising a plurality of connecting arms extending substantially radially outwards and contacting the connecting surfaces of corresponding pole bodies;
a plurality of commutator bars fixed to the commutator base; and
a plurality of coils, at least two of the coils being wound around a corresponding pole body and the connecting arm contacting the connecting surface of said corresponding pole body.

2. The rotor of claim 1, wherein the number of connecting arms is equal to the number of pole bodies.

3. The rotor of claim 1, wherein the connecting arms are evenly arranged in the circumferential direction of the rotor.

4. The rotor of claim 1, wherein the width of the connecting arm in the circumferential direction of the rotor is substantially equal to the width of the pole body.

5. The rotor of claim 1 further comprising a ring-shaped varistor, wherein the varistor surrounds and is electrically connected to the commutator bars.

6. The rotor of claim 1 further comprising a retaining ring tightly sleeved on an end of the commutator bars so as to fix the commutator bars to the commutator base.

7. The rotor of claim 6 further comprising a ring-shaped varistor and a plurality of conductive extending portions extending radially outwards from respective commutator bars, wherein the varistor is supported by and electrically connected to the extending portions, and radially surrounds the retaining ring.

8. The rotor of claim 1, wherein the rotor core further comprises at least one groove, the commutator base further comprises at least one protrusion received in the groove for positioning the commutator base with respect to the rotor core.

9. The rotor of claim 1, wherein the rotor core further comprises a substantially tubular root that fixedly sleeves part of the shaft, the pole bodies extend from the root, a plurality of grooves are formed in an axial end of the root adjacent to the shaft and the commutator base has a plurality of protrusions received in the grooves.

10. The rotor of claim 1, wherein the rotor core further comprises a substantially tubular root that fixedly sleeves part of the shaft and a plurality of pole heads, the pole bodies extend from the root to respective pole heads, a groove is formed in each joint between each pole body and the corresponding pole head and the commutator base has a number of protrusions respectively received in the grooves.

11. The rotor of claim 1, wherein the rotor core further comprises a substantially tubular root that fixedly sleeves part of the shaft with the pole bodies extending from the root, and protrusions formed on the commutator base contact a radially outer surface of the root between adjacent pole bodies to circumferentially align the commutator with the rotor core.

12. A motor comprising:
a stator having magnetic poles;
a plurality of brushes; and
a rotor rotatably received in the stator,
the rotor comprising:
a rotor core having a plurality of pole bodies extending substantially radially outwards, each pole body having a connecting surface at an axial end of the rotor core;
a commutator having a base supporting a plurality of commutator bars in sliding contact with the brushes, the base having a plurality of connecting arms that extend substantially radially outwards and in contact with the connecting surfaces of corresponding pole bodies; and
a plurality of coils wound about the pole bodies and connected to the commutator bars, at least two of the coils are wound around a corresponding pole body and the connecting arm contacting the connecting surface of said corresponding pole body.

13. The motor of claim 12, wherein the stator comprises a plurality of permanents magnets forming the magnetic poles.

14. The motor of claim 13, wherein the stator further comprises a housing that receives the permanents magnets and an end cap that substantially closes an end of the housing, an end of each brush is fixed to the end cap.

15. The motor of claim 14, wherein the stator further comprises a plurality of motor terminals for connecting a power source; the end cap comprises an end plate and two projections extending perpendicularly from the end plate at spaced locations and abutting against an inner wall of the housing, each projection comprises a slot that receives a respective motor terminal and an end of a corresponding brush.

16. The motor of claim 12, wherein the number of connecting arms is equal to the number of pole bodies.

17. The motor of claim 12, wherein the connecting arms are evenly arranged in the circumferential direction of the rotor.

18. The motor of claim 12, wherein the width of the connecting arm in the circumferential direction of the rotor is substantially equal to the width of the pole body.

19. The motor of claim 12, wherein the commutator bars are fitted to the commutator base and a retaining ring tightly sleeves an end of the commutator bars to fix the bars to the base.

20. The motor of claim 12, wherein the rotor core further comprises a groove in an axial end surface of the rotor core facing the commutator, the commutator further comprises a protrusion protruding toward the rotor core and received in the a groove for positioning the commutator base with respect to the rotor core.
